(19) United States
(12) Patent Application Publication
(10) Pub. No.: US 2015/0115011 A1
(43) Pub. Date: Apr. 30, 2015

(54) SECURING DEVICE FOR ON BICYCLE CARRY RACK

(71) Applicant: KING RACK INDUSTRIAL CO., LTD., Taichung City (TW)

(72) Inventor: Chiu-Kuei Wang, Taichung City (TW)

(73) Assignee: KING RACK INDUSTRIAL CO., LTD., Taichung City (TW)

(21) Appl. No.: 14/065,422

(22) Filed: Oct. 29, 2013

(51) Int. Cl. B60R 9/10

(52) U.S. Cl. CPC B60R 9/10
USPC 224/568

(57) ABSTRACT

A securing device includes a base, a positioning member and a belt. The positioning member has a lever pivotably connected thereto and an insertion hole is defined between the inside of the lever and the positioning member. A tooth extends from the inside of the lever and located in the insertion hole. The base is mounted to the bicycle carry rack and the positioning member is connected to the base. The bicycle frame is accommodated in the positioning member. The belt has one end connected to the base and the other end of the belt inserted into the insertion hole. The belt has multiple engaging notches and the tooth on the lever is engaged with one of the engaging notches to secure the bicycle frame between the belt and the positioning member. The tooth is disengaged from the engaging notch to release the belt by pivoting the lever.

### FIELD OF THE INVENTION

The present invention relates to a bicycle carry rack, and more particularly, to a securing device for positioning a bicycle frame on the bicycle carry rack.

### BACKGROUND OF THE INVENTION

The conventional bicycle carry racks are designed to be connected to the rear end of the car and is able to carry bicycles with the car. There are two types of carry rack available, one of which includes grooves in which the bicycle frames are secured, and the other type is a trailer which is moved with the car and the bicycles are located in the trailer. The conventional bicycle carry rack has a connection member so as to be connected with the hitch, or the bicycle carry rack directly attached to the rear end of the car by hooks and tightening strips. There are many tightening strips are used to secure the bicycle to the carry rack, most of the tightening strips are made by plastic which has a head on one end and the other end of the tightening strip extends through the head. Multiple teeth are formed on the tightening strip and one of the teeth is engaged with a locking tooth in the head so as to tighten the bicycle frame, such as the top tube, to the carry rack.

However, the tightening strip is mounted to outside of the bicycle frame and most of the bicycle frames and the carry rack are composed by round tubes, so that the contact area between the bicycle frames and the carry rack is small. Therefore, the bicycles on the carry rack easily shake when the car moves along a rugged road. The plastic-made tightening strips do not have proper flexibility to match the curvatures of the bicycle frames and the carry rack. This causes the bicycles to be loosened during transportation.

When dismounting the bicycles from the carry rack, the plastic-made tightening strips have to be cut, and this causes waste and the user has to prepare scissors or knifes. Besides, when the bicycles are secured to the carry rack again, new tightening strips are required.

The present invention intends to provide a securing device for positioning a bicycle frame on the bicycle carry rack so as to improve the shortcomings mentioned above.

### SUMMARY OF THE INVENTION

The present invention relates to a securing device and comprises a base having a first outer plate and a second outer plate on two sides thereof. A connection plate is connected between the first and second outer plates. A recess is defined between the first and second outer plates and the connection plate. A C-shaped part extends from an end of the connection plate and a first passage is defined transversely through the C-shaped part. The first outer plate has a first notch defined therein. The second outer plate has a lever pivotably connected thereto. At least one tooth extends from the inside of the lever. An insertion hole is defined between the inside of the lever and the second outer plate. The at least one tooth is located in the insertion hole.

A positioning member is located between the first and second outer plates of the base. The positioning member has a groove which accommodates a bicycle frame. A slit is defined in the positioning member and located below the groove. The connection plate of the base is inserted into the slit.

A belt has a head on the first end thereof and the head is movably engaged with the first notch of the base. Multiple engaging notches are defined in the surface of the belt. The second end of the belt is inserted into the insertion hole and the at least one tooth of the lever is engaged with one of the engaging notches to secure the bicycle frame. When pivoting the lever, the at least one tooth of the lever is disengaged from the engaging notch so that the belt is able to be pulled out from the insertion hole.

The primary object of the present invention is to provide a securing device for securing a bicycle on a bicycle carry rack, and no extra tool is needed.

By the engagement between the at least one tooth of the lever and one of the engaging notches of the belt, the bicycle frame is secured to the bicycle carry rack.

The operation of the belt is easy and convenient without any tool. The belt is simply inserted into the insertion hole to let the at least one tooth of the lever be engaged with the engaging notch of the belt to secure the bicycle frame. When pivoting the lever, the at least one tooth of the lever is disengaged from the engaging notch so that the belt is able to be pulled out from the insertion hole. The lever has proper flexibility and can be pivoted back to its original position. The release of the belt does not need to use any tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the securing device of the present invention;

FIG. 2 is an exploded view to show the securing device of the present invention;

FIG. 3 is a perspective view to show that the belt of the securing device of the present invention is in secured position;

FIG. 4 is a side cross sectional view to show the securing device of the present invention;

FIG. 5 is an end cross sectional view to show the securing device of the present invention, wherein the belt is not yet inserted into the insertion hole;

FIG. 6 is an end cross sectional view to show the securing device of the present invention, wherein the belt is inserted into the insertion hole;

FIG. 7 is an end cross sectional view to show the securing device of the present invention, wherein the belt is inserted into the insertion hole and the tooth of the lever is engaged with one of the engaging notches of the belt, and

FIG. 8 is an end cross sectional view to show the securing device of the present invention, wherein the lever is pivoted to remove the tooth of the lever from the engaging notch of the belt.

### DETAILED DESCRIPTION OF THE PREFERRED EMBODIMENT

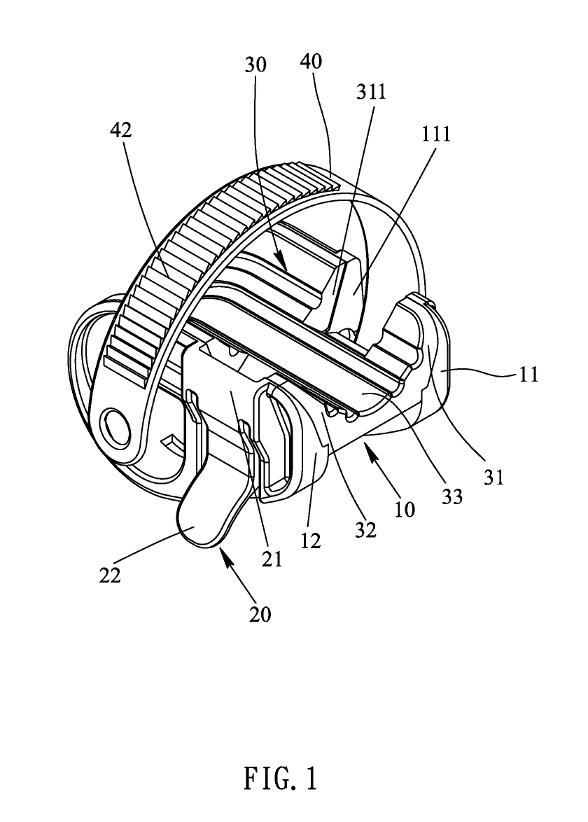

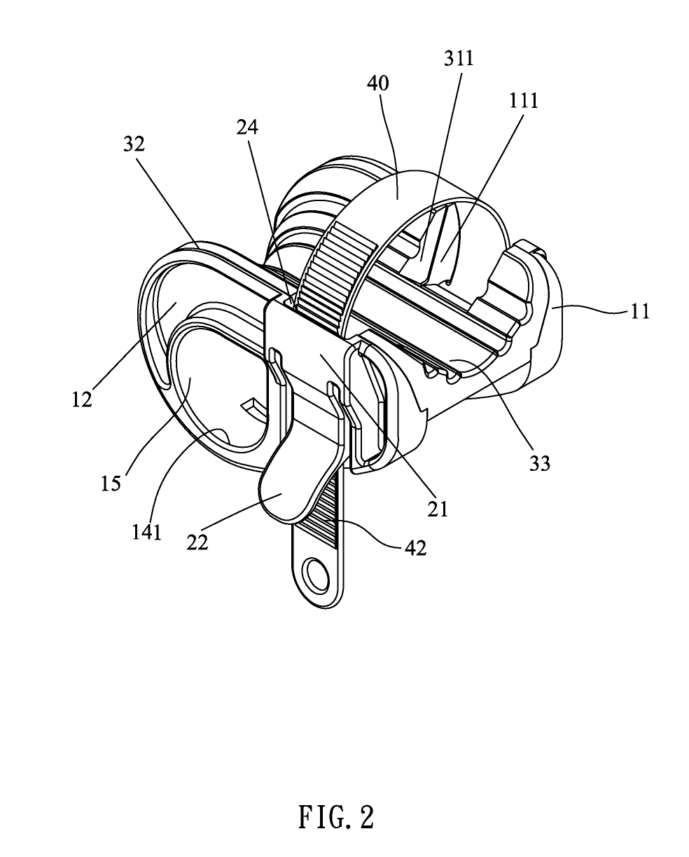

Referring to FIGS. 1 and 2, the securing device for positioning a bicycle frame to a bicycle carry rack of the present invention comprises a base 10, a positioning member 30, and a belt 40. The positioning member 30 is connected to the base 10 and the bicycle frame 50 is positioned in the positioning member 30. The belt 40 has a first end connected to the base 10 and a second end of the belt 40 secures the bicycle frame 50.

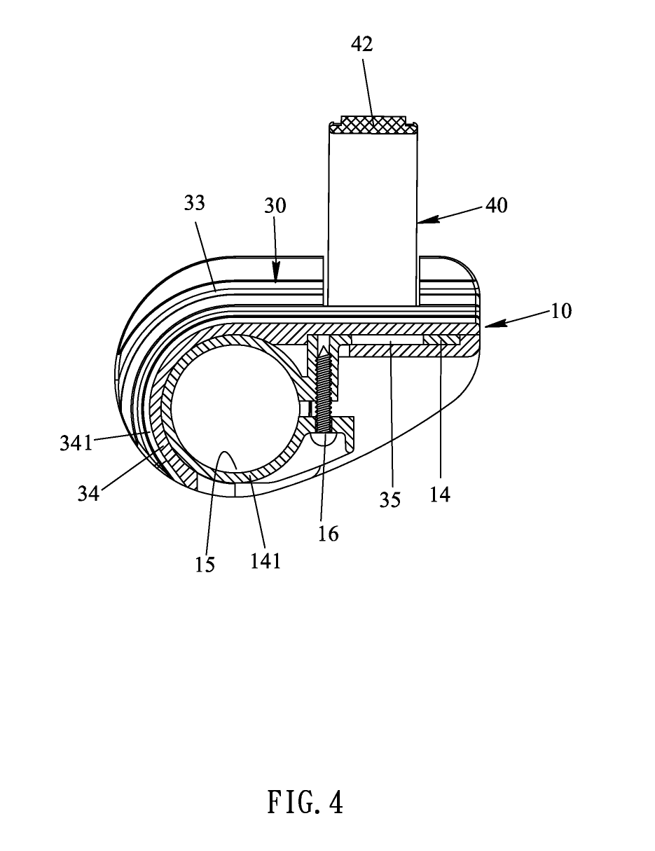

The base 10 comprises a first outer plate 11 and a second outer plate 12 on two sides thereof. A connection plate 14 is connected between the first and second outer plates 11, 12, a recess 13 is defined between the first and second outer plates 11, 12 and the connection plate 14. A C-shaped part 141 extends from one end of the connection plate 14 and a first passage 15 is defined transversely through the C-shaped part 141 as shown in FIG. 4. The axis of the first passage 15 of the C-shaped part 141 is perpendicular to the first and second outer plates 11, 12. The C-shaped part 141 has two extensions between which an opening is formed. A bolt 16 is threadedly connected to the two extensions to control a size of the first passage 15 of the C-shaped part 141. The first outer plate 11 has a first notch 111 defined therein. A slot 17 is defined in the inner end of the first notch 111 and located beneath the first notch 111. The slot 17 is perpendicular to the first passage 15.

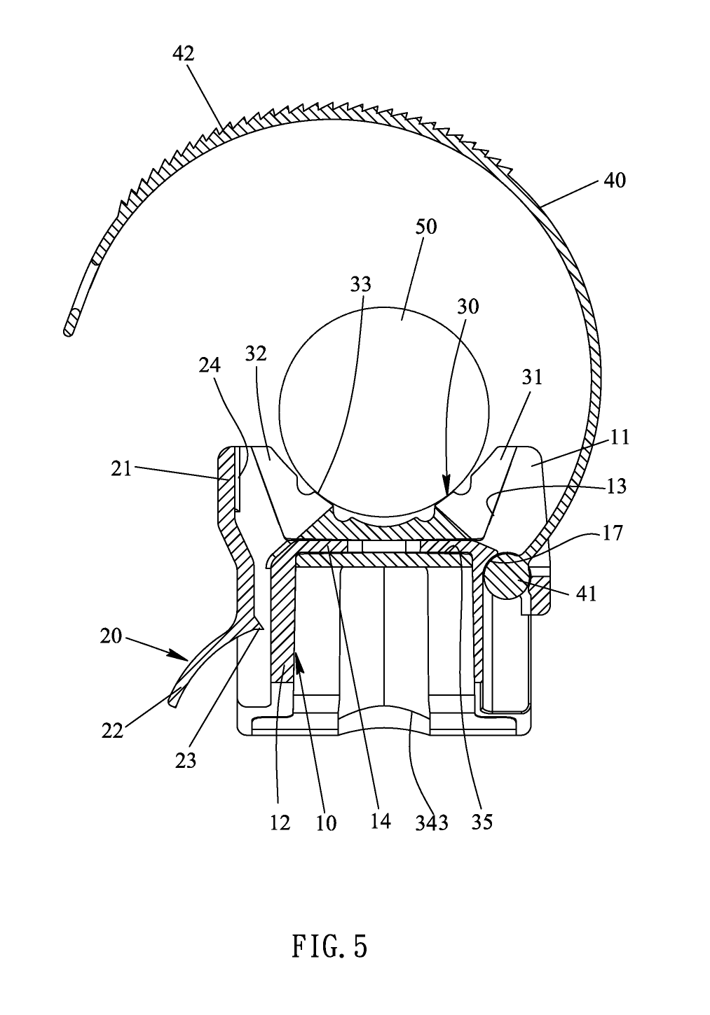

The second outer plate 12 has a lever 20 pivotably connected thereto. The lever 20 has a shoulder plate 21, an operation portion 22 and at least one tooth 23. The shoulder plate 21 extends downward from the top of the second outer plate 12 and the operation portion 22 extends from the shoulder plate 21 at an angle. The at least one tooth 23 extends from the inside of the lever 20 as shown in FIG. 5. An insertion hole 24 is defined in the inside of the lever 20 and extends toward the operation portion 22. In detail, the insertion hole 24 is defined between the inside of the lever 20 and the second outer plate 12. The at least one tooth 23 is located in the insertion hole 24.

The positioning member 30 has a first inner plate 31 and a second inner plate 32 on two sides thereof. The positioning member 30 is located between the first and second outer plates 11, 12 of the base 10. The positioning member 30 has a groove 33 which is a semi-circular recess and defined in the surface of the plate connected between the first and second inner plates 31, 32. A C-shaped holding plate 34 extends from one end of the plate with the groove 33. A second passage 341 is defined transversely through the holding plate 34. An inverted L-shaped support plate 342 is connected to the opening of the C-shaped holding plate 34. A slit 35 is defined between the underside of the portion defining the groove 33 and the inverted L-shaped support plate 342. The connection plate 14 of the base 10 is inserted into the slit 35. A U-shaped opening 343 is defined between the support plate 342 and the holding plate 34, the U-shaped opening is located beneath the slit 35. The first inner plate 31 of the positioning member 30 has a second notch 311 which is located corresponding to the first notch 111. The second inner plate 32 of the positioning member 30 has a third notch 321 which is located corresponding to the insertion hole 24.

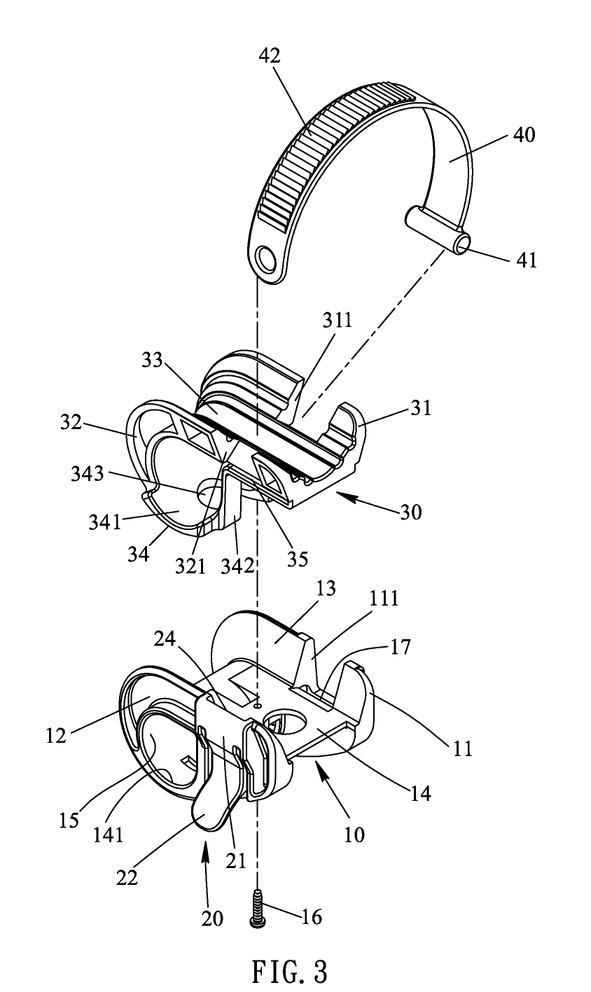

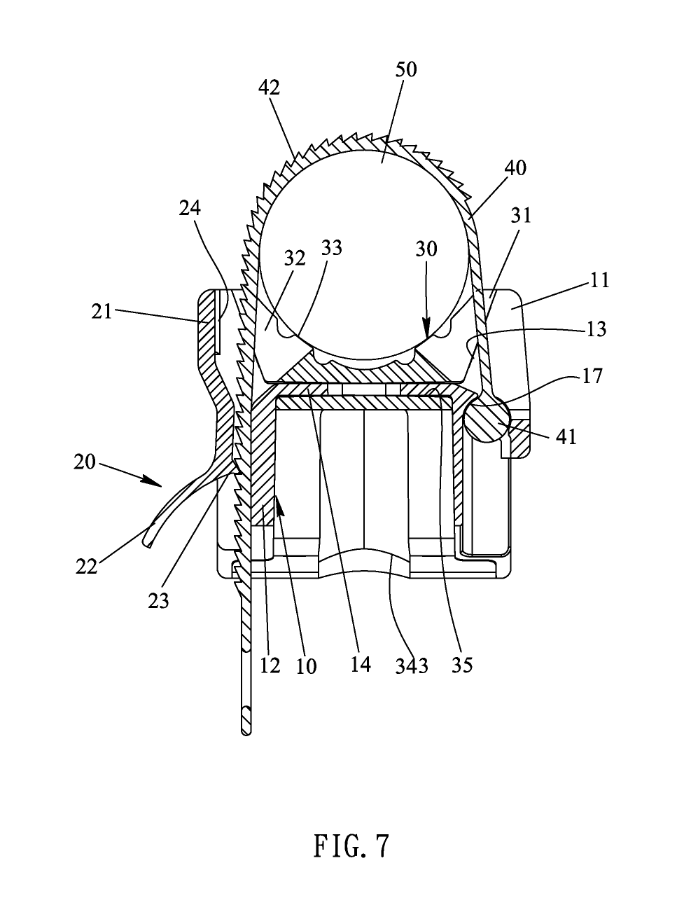

The belt 40 has a head 41 on the first end thereof and the head 41 is movably engaged with the slot 17 of the base 10. Multiple engaging notches 42 are defined in the surface of the belt 40 as shown in FIGS. 3 and 7. The second end of the belt 40 is inserted into the insertion hole 24, and the at least one tooth 23 of the lever 20 is engaged with one of the engaging notches 42 to secure the bicycle frame 50.

As shown in FIGS. 1, 2 and 4, the first and second inner plates 31, 32 of the positioning member 30 are located between the first and second outer plates 11, 12 of the base 10. The holding plate 34 is mounted to the C-shaped plate 141, the connection plate 14 is inserted into the slit 35. As shown in FIG. 5, one part of the bicycle carry rack extends through the first passage 15 and the bolt 16 tightens the U-shaped opening 343 so that the securing device is fixed to the bicycle carry rack.

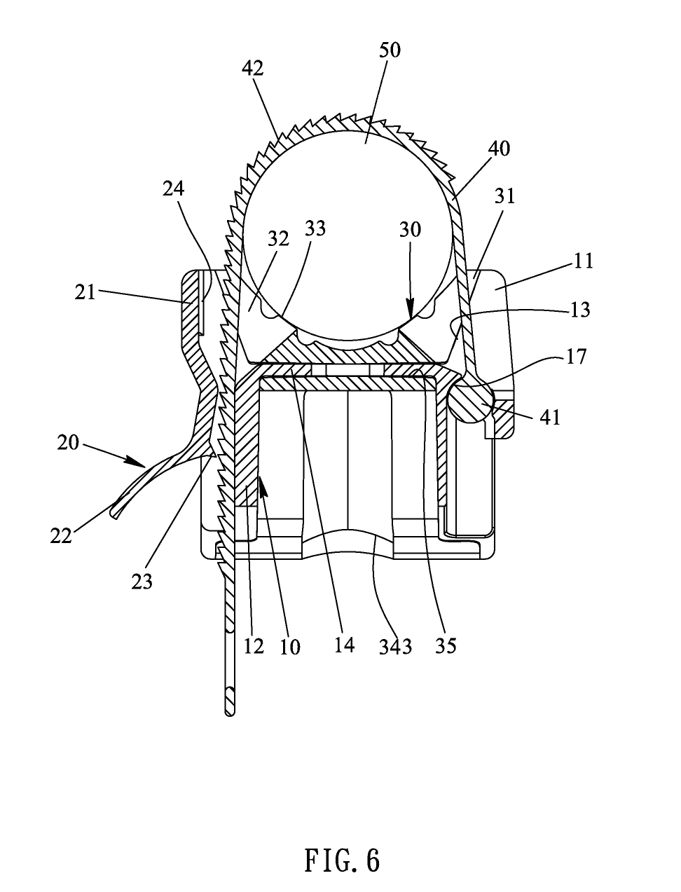

As shown in FIGS. 3, 5 and 6, the top tube of the bicycle frame 50 is accommodated in the groove 33 of the positioning member 30, and the second end of the belt 40 goes across the top tube and then inserted into the insertion hole 24. The operation portion 22 of the lever 20 is operated to pivot the lever 20 so that the at least one tooth 23 is removed from the belt 40. When the belt 40 tightly secure the top tube, the lever 20 is released as shown in FIGS. 6 and 7, the lever 2 has proper flexibility so that the lever 20 bounces back and the at least one tooth 23 is engaged with one of the engaging notches 42. The engaging notches 42 of the belt 40 are shaped such that the at least one tooth 23 does not disengaged from the engaging notch 42 once being engaged. The bicycle frame 50 is then well secured.

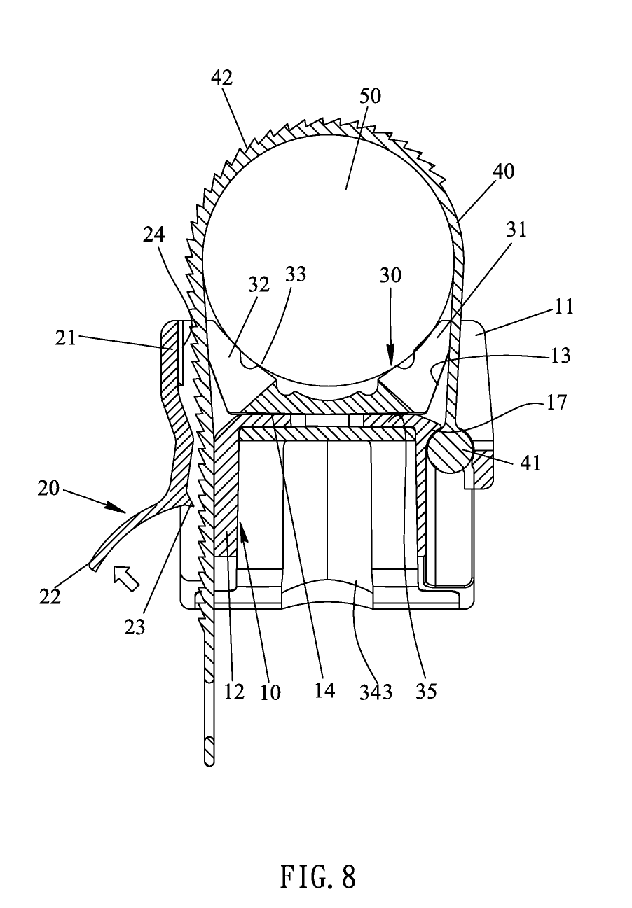

As shown in FIG. 8, when lifting the operation portion 22 of the lever 20, because the lever 20 is connected to the shoulder plate 21 and has flexibility, so that the at least one tooth 23 of the lever 20 is disengaged from the engaging notch 42, and the belt 40 is able to be pulled out from the insertion hole 24. The bicycle frame 50 is then released from the securing device. After the user releases the operation portion 22, the lever 20 returns to its original position, the operation processes do not need any tool.

While we have shown and described the embodiment in accordance with the present invention, it should be clear to those skilled in the art that further embodiments may be made without departing from the scope of the present invention.

What is claimed is:

1. A securing device comprising:
a base having a first outer plate and a second outer plate on two sides thereof, a connection plate connected between the first and second outer plates, a recess defined between the first and second outer plates and the connection plate, a C-shaped part extending from an end of the connection plate and a first passage defined transversely through the C-shaped part, the first outer plate having a first notch defined therein, the second outer plate having a lever pivotably connected thereto, at least one tooth extending from an inside of the lever, an insertion hole defined between the inside of the lever and the second outer plate, the at least one tooth located in the insertion hole;
a positioning member located between the first and second outer plates of the base, the positioning member having a groove which is adapted to accommodate a bicycle frame, a slit defined in the positioning member and located below the groove, the connection plate of the base is inserted into the slit, and
a belt having a head on a first end thereof and the head movably engaged with the first notch of the base, multiple engaging notches defined in a surface of the belt, a second end of the belt inserted into the insertion hole, the at least one tooth of the lever engaged with one of the engaging notches to be adapted to secure the bicycle frame, when pivoting the lever, the at least one tooth of the lever being disengaged from the engaging notch so that the belt is able to be pulled out from the insertion hole.

2. The securing device as claimed in claim 1, wherein the C-shaped part has two extensions between which an opening is formed, a bolt threadedly extends through the two extensions to control a size of the first passage of the C-shaped part, an axis of the first passage of the C-shaped part is perpendicular to the first and second outer plates.

3. The securing device as claimed in claim 2, wherein a slot is defined in the base and located beneath the first notch, the slot is perpendicular to the first passage, the head of the belt is located in the slot.

4. The securing device as claimed in claim 1, wherein the lever has a shoulder plate and an operation portion, the shoulder plate extends downward from a top of the second outer plate and the lever extends from the shoulder plate, the operation portion extends from the lever at an angle, the insertion hole is defined in the inside of the lever and extends toward the operation portion.

5. The securing device as claimed in claim 1, wherein the positioning member is located in the recess between the first and second outer plates of the base, the positioning member has a first inner plate and a second inner plate on two sides thereof, the groove is a semi-circular recess and defined in a surface of a plate connected between the first and second inner plates, a C-shaped holding plate extends from one end of the plate with the groove, a second passage is defined transversely through the holding plate, an inverted L-shaped support plate connected to an opening of the C-shaped holding plate, the slit is defined between the groove and the inverted L-shaped support plate.

6. The securing device as claimed in claim 5, wherein the first inner plate of the positioning member has a second notch which is located corresponding to the first notch, the second inner plate has a third notch which is located corresponding to the insertion hole.

7. The securing device as claimed in claim 5, wherein a U-shaped opening is defined between the support plate and the holding plate, the U-shaped opening is located beneath the slit.
